(19) United States
(12) Patent Application Publication
(10) Pub. No.: US 2007/0285912 A1
(43) Pub. Date: Dec. 13, 2007

(54) Antenna with lighting function

(75) Inventor: Hsin-Lung Lin, Hsinchu (TW)

Correspondence Address: RABIN & Berdo, PC, 1101 14TH STREET, NW, SUITE 500, WASHINGTON, DC, 20005, US

(73) Assignee: SmartAnt Telecom Co., Ltd., Hsinchu County (TW)

(21) Appl. No.: 11/808,327

(22) Filed: Jun. 8, 2007

(30) Foreign Application Priority Data
Jun. 9, 2006 (TW) 095210172

(51) Int. Cl. G03B 15/02

(52) U.S. Cl. 362/4; 362/803

(57) ABSTRACT

An antenna with a lighting function includes an accommodation body, a light-transmissive head, a light source, and an antenna component. The accommodation body has an accommodation space therein, and the light-transmissive head is disposed on the accommodation body and allows lights to transmit through. The light source is disposed within the light-transmissive head, and emits a light that is transmitted out of the light-transmissive head. Finally, the antenna component is accommodated within the accommodation body, for transmitting wireless signals and for lighting.

### CROSS-REFERENCE TO RELATED APPLICATIONS

This non-provisional application claims priority under 35 U.S.C. § 119(a) on Patent Application No(s). 095210172 filed in Taiwan, R.O.C. on Jun. 9, 2006, the entire contents. of which are hereby incorporated by reference.

### BACKGROUND OF THE INVENTION

1. Field of the Invention

The present invention relates to an antenna, and more particularly to an antenna capable of protecting an antenna component and having a lighting function.

2. Related Art

With the rapid development and innovation of electronic science and technology, electronics are more and more frequently used by common people in daily life. “Electric” and “magnetic” phenomena occur everywhere in the daily life, besides natural sunlight and lightning, all kinds of electrical appliances, such as televisions, microwaves, lamps, and computers, are electronic products. Furthermore, electromagnetic radio waves of broadcasting stations, TV stations, taxi radios, and satellite mobile communications also exist in the environment. However, the intensity of radio waves reduces rapidly as the distance increases. Therefore, it is safe and secure to use these electronic products as long as an appropriate distance is kept from the sources of the electromagnetic waves. In the air, the intensity of the electromagnetic waves is attenuated to one fourth as the distance is doubled. Actually, when the radio waves pass through obstacles such as trees or various buildings, the attenuation rate of the intensity will become even higher.

Therefore, a mobile communication network is geographically divided into several divisions, which are referred to as “cells”. Each cell has a wireless base station at the center for receiving and transmitting signals. Mobile phones are tools for users to link to the cell network. According to the distribution of network, the user can still make phone calls even if he/she has passed across boundaries between the cells. In order to realize the communication, wireless signals are received and transmitted between the mobile phones and the base stations. However, in order to obtain desirable voice quality, the power of the signals is often adjusted, and meanwhile, the signals are strictly restricted, so as not to interfere with other radio systems, such as emergency communications, taxies, and broadcasting and TV systems. However, as the prevailing of mobile phones, in order to improve the voice quality, persons skilled in the communication industry are actively looking for places to set up the antenna base stations in downtown area with condensed population, and are researching on better mode for signal transmission.

However, in order to avoid the interference of electromagnetic waves during the signal transmission, signal transmission tools, such as antenna base stations, are mostly established outside buildings. However, the antenna base stations are often damaged due to climate changes of the environment and human factors, which further influences or interferes with the signal transmission quality, and also causes troubles in future maintenance. Moreover, in recent years, the mobile communication becomes more and more popular, and its application rate of the mobile is still increasing as the development of 3G mobile communication system. In this trend, more antenna base stations must be established. However, common people are concerned about diseases that may be caused by the electromagnetic wave radiation of the communication systems, which even results in many complaints and protests. In another aspect, the voice quality of customers must be maintained. Therefore, it has become an urgent task to take both public concerns and voice quality into consideration at the same time.

Therefore, conventional signal transmission tools, no matter established indoors or outdoors, cannot maintain desirable voice quality because of protests in fear of the electromagnetic wave radiation or because of damages caused by outside climate or human factors. Moreover, in downtown areas where space is precious, the antennae must occupy some space that might be used for other public facilities. Therefore, it is also another important technical issue to reduce the space occupied by the antennae.

### SUMMARY OF THE INVENTION

In view of the above problems of the conventional art, the present invention is directed to an antenna with a lighting function, which conceals an antenna component to realize camouflage and protection effects, and provides an additional lighting function, such that the antenna is combined with general public facilities to improve the space utilization rate.

In order to achieve the aforementioned objectives, the present invention provides an antenna with a lighting function, which includes an accommodation body, a light-transmissive head, a light source, and an antenna component. The accommodation body has an accommodation space therein, and the light-transmissive head is disposed on the accommodation body and allows light to transmit through. The light source is disposed within the light-transmissive head, and emits a light that is transmitted out of the light-transmissive head. Finally, the antenna component is accommodated within the accommodation body, for transmitting signals and for lighting.

The advantages of the present invention are described as follows. As the antenna component is accommodated within the accommodation body in the present invention, the functions of both camouflaging and protecting the antenna component can be achieved, so as to relieve the mass' concerns about the antenna, and to reduce the damages to the antenna component, which further reduces the maintenance cost. Meanwhile, the present invention integrates the lighting function, such that the antenna can serve as a street lamp as well, so as to reduce the competition on space between the antenna and general public facilities, and thus improving the space utilization rate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The above description of the content of the present invention and the following illustration of embodiments are intended to demonstrate and explain the principles of the present invention, and provide a further explanation on the claims of the present invention.

### BRIEF DESCRIPTION OF THE DRAWINGS

The present invention will become more fully understood from the detailed description given herein below for illustration only, which thus is not limitative of the present invention, and wherein:

FIG. 1 is a schematic perspective view of an antenna with a lighting function of the present invention;

FIG. 2 is a schematic sectional view of the antenna with a lighting function of the present invention; and

FIG. 3 is a schematic view of the antenna with a lighting function of the present invention applied on a road.

### DETAILED DESCRIPTION OF THE INVENTION

To make the object, structure, features, and functions of the present invention be more understandable, the present invention is illustrated below in detail with reference to embodiments.

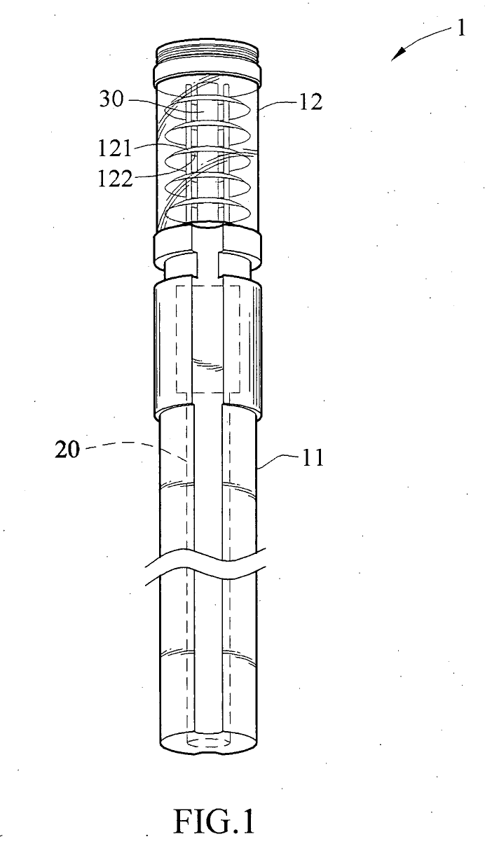

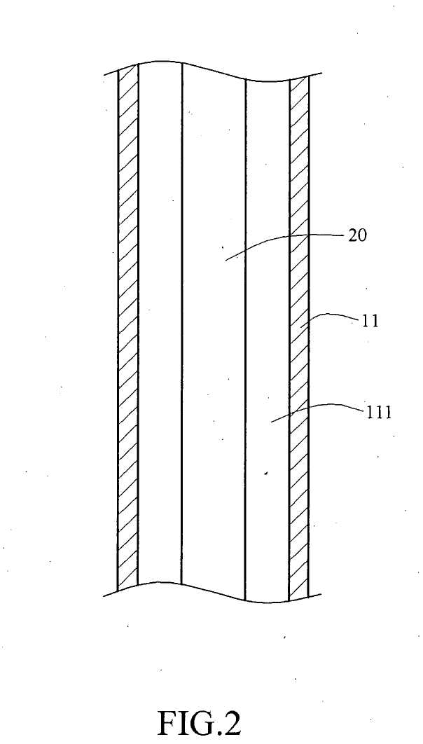

Firstly, referring to FIGS. 1 and 2, an antenna with a lighting function is disclosed in an embodiment of the present invention that integrates an antenna component with public lighting facilities. The antenna 1 with a lighting function includes an accommodation body 11, a light-transmissive head 12, an antenna component 20, and a light source 30.

The accommodation body 11 is a non-transparent tube, and has an accommodation space 111 therein for accommodating the antenna component 20. One end of the accommodation body 11 is disposed in the ground, and the other end is used for mounting the light-transmissive head 12. The light-transmissive head 12 is disposed on the accommodation body 11 and allows light to transmit through. The light source 30 is disposed within the light-transmissive head 12, and emits a light that is transmitted out of the light-transmissive head 12. The light source 30 is configured in a long tubular shape, and can be a fluorescent bulb, a fluorescent lamp tube, or a halogen lamp tube.

In order to enhance the luminance level, and project the lights of the light source 30 downwards, the antenna with a lighting function 1 further includes at least one reflective cover 121 disposed within the light-transmissive head 12, so as to reflect the lights emitted by the light source 30, and project the lights downwards. A hole 122 is opened on the reflective cover 121 through a central part thereof, such that the light source 30 is accommodated within the hole 122 by passing there through. Therefore, the light emitted by the light source 30 is reflected outwards by the reflective cover 121, so as to realize the lighting function.

The antenna component 20 is a cable accommodated within the accommodation space 111 of the accommodation body 11 and extending from one end of the accommodation body 11 to the other end along the axle center of the accommodation body 11, so as to well protect the antenna component 20 from damages caused by climate and human factors. In case that flexible wires, such as power wires for the light source 30 or other antenna components 20 for different channels, need to be added in future, these wires can be accommodated as well depending upon the size of the accommodation space 111 of the accommodation body 11. The antenna component 20 is used for receiving, transmitting, and emitting signals, and the light source provides the lighting effect, and thus, the present invention has functions of both signal transmission and lighting.

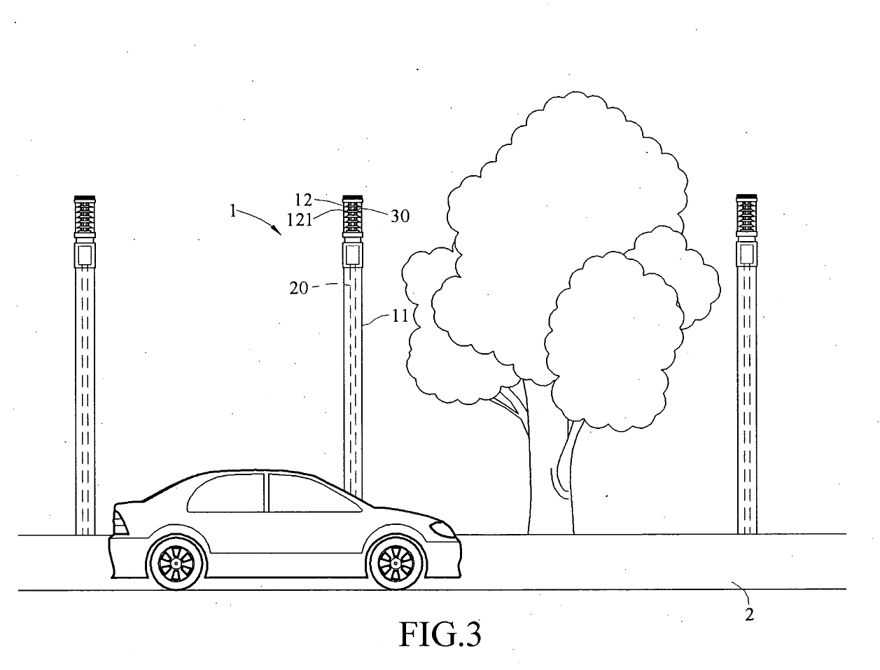

FIG. 3 shows an application of the antenna 1 with a lighting function of the present invention. As general public are concerned and worried about the positions where the antenna is installed, an outdoor antenna component 20 is easy to get damaged and the antennae often occupy spaces for public facilities such as street lamps, the positions to establish the antennae are limited. When the antenna 1 with a lighting function is set up on a road 2 for passengers or vehicles, the lighting and luminance can be enhanced, so as to prevent traffic accidents. Meanwhile, as the antenna component 20 is accommodated within the accommodation body 11, the signals can still be transmitted, and the signal quality when receiving, transmitting and emitting signals can be maintained at a high level. Therefore, the effects of camouflage, desirable signal quality, and protection of the antenna component 20 are achieved at the same time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An antenna with a lighting function, comprising:
an accommodation body, having an accommodation space therein;
a light-transmissive head, disposed on the accommodation body and allowing lights to transmit through;
a light source, disposed within the light-transmissive head, for emitting a light that is transmitted out of the light-transmissive head; and
an antenna component, accommodated within the accommodation body for transmitting wireless signals.

2. The antenna with a lighting function as claimed in claim 1, wherein the antenna component is a cable.

3. The antenna with a lighting function as claimed in claim 1, further comprising at least one reflective cover disposed within the light-transmissive head, for reflecting the light emitted by the light source.

4. The antenna with a lighting function as claimed in claim 3, wherein the reflective cover has a hole, and the light source is tubular and accommodated within the hole by passing there through.

5. The antenna with a lighting function as claimed in claim 3, comprising a plurality of reflective covers disposed within the light-transmissive head in parallel.

6. The antenna with a lighting function as claimed in claim 1, wherein the accommodation body is a tube.
